(19) United States
(12) Patent Application Publication
(10) Pub. No.: US 2007/0022592 A1
(43) Pub. Date: Feb. 1, 2007

(54) Prying tools

(75) Inventors: Si-Wei Zhou, Jiangsu (CN); Zhi-Huang Lian, Jiangsu (CN)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/491,136

(22) Filed: Jul. 24, 2006

(30) Foreign Application Priority Data
Jul. 26, 2005 (TW) 94125281

(51) Int. Cl. B23P 19/04

(52) U.S. Cl. 29/239

(57) ABSTRACT

Prying tools are provided. A prying tool is used to separate engaged objects having a groove formed where the objects meet. A prying tool includes a pair of pivotally interconnected handles each having a prying slice at one end. The prying slices can be partly inserted into the groove when tightly closed.

### BACKGROUND

The invention relates to prying tools, and in particular, to prying tools separating engaged plastic objects efficiently.

Liquid crystal displays (LCDs) are common electronic devices. Typically, plastic front and back covers of a LCD include corresponding engaging structures. The corresponding engaging structures are purposely designed such that the plastic front and back covers are engaged firmly. Thus, it may be difficult to separate the covers manually for replacement or repair.

Usually, a flat screwdriver inserted between the plastic front and back covers is used to prize the plastic front and back covers. However, the plastic front and back covers can be damaged or deformed in this way, thus wasting time, efforts, and materials.

### SUMMARY

Prying tools are provided. A prying tool is used to separate engaged objects having a groove formed where the objects meet. An exemplary embodiment of a prying tool includes a pair of handles and a pair of prying slices. The pair of handles is interlaced and rotatably pivoting on each other. The pair of prying slices is disposed on the pair of handles respectively. The pair of prying slices can be partly inserted into the groove when tightly closed.

Some embodiments of a prying tool include a pair of handles and a pair of prying slices. The pair of handles is interlaced and rotatably pivoting on each other. Each handle comprises a long arm portion and a short arm portion respectively on two sides of a pivot point on which the pair of handles pivots. The pair of prying slices is disposed on the pair of short arm portions respectively. The pair of prying slices can be partly inserted into the groove when tightly closed.

### DESCRIPTION OF THE DRAWINGS

The invention can be more fully understood by reading the subsequent detailed description and examples with references made to the accompanying drawings, wherein:

FIG. 1a is a diagram of an embodiment of a prying tool, wherein a pair of prying slices is tightly closed;

FIG. 1b is a diagram of an embodiment of a prying tool, wherein a pair of prying slices is separated;

FIG. 2a is a schematic diagram of an embodiment of a prying tool, wherein a pair of prying slices is inserted into a groove of a liquid crystal display (LCD);

FIG. 2b is an enlarged diagram of a dotted-line portion A in FIG. 2a; and

FIG. 2c is a cutaway view along a line B in FIG. 2a.

### DETAILED DESCRIPTION

Prying tools are described in greater detail in the following.

A principle aim of the invention is to provide a pair of prying slices on a pair of handles of a prying tool. The pair of handles is interlaced and rotatably pivoted on each other. After inserting the pair of prying slices into a groove of a liquid crystal display (LCD) where the plastic front cover and the plastic back cover meet, the plastic front cover and the plastic back cover thereof can be separated easily.

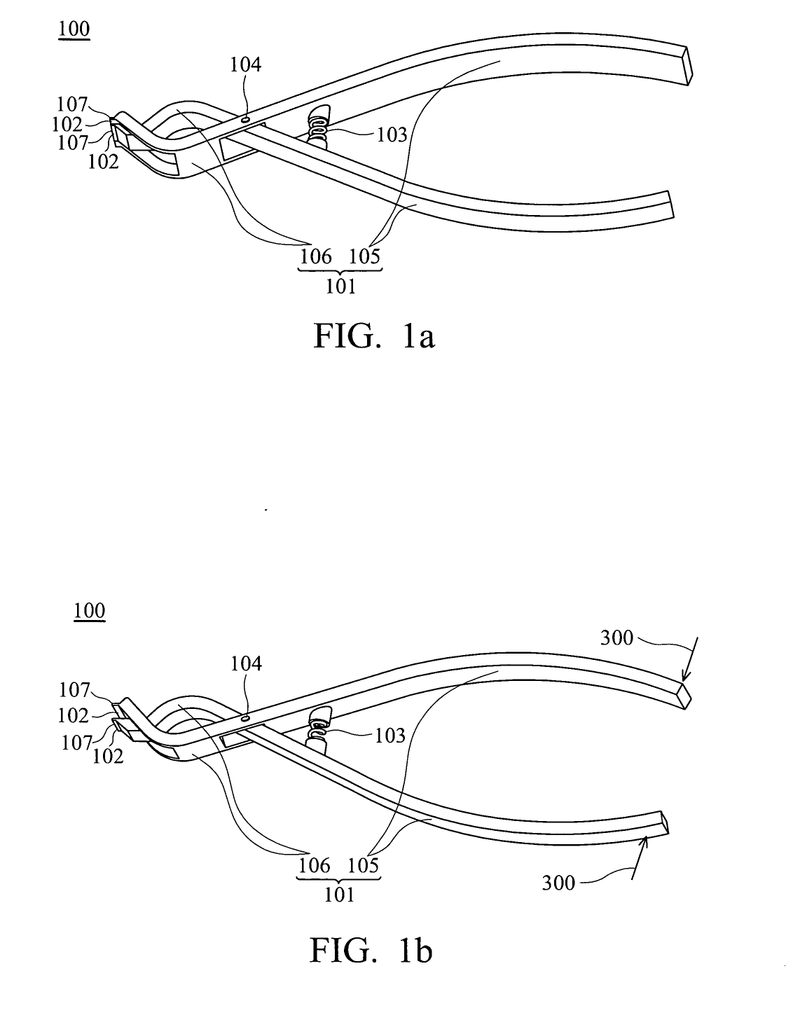

FIG. 1a is a diagram of an embodiment of a prying tool 100, wherein a pair of prying slices 102 is tightly closed. FIG. 1b is a diagram of the prying tool 100, wherein the pair of prying slices 102 is separated.

The prying tool 100 includes a pair of handles 101, a pair of prying slices 102, and an elastic component 103.

The pair of handles 101 is interlaced and rotatably pivoted on each other. Each handle 101 includes a long arm portion 105 and a short arm portion 106 respectively on two sides of a pivot point 104 on which the pair of handles 101 pivots.

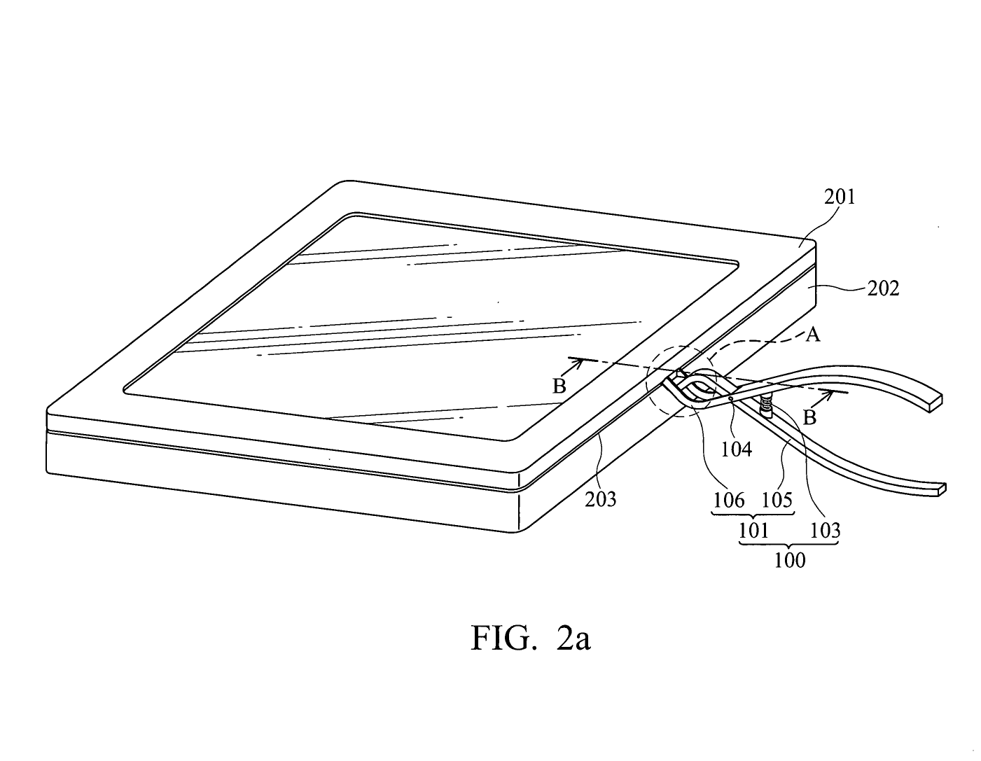

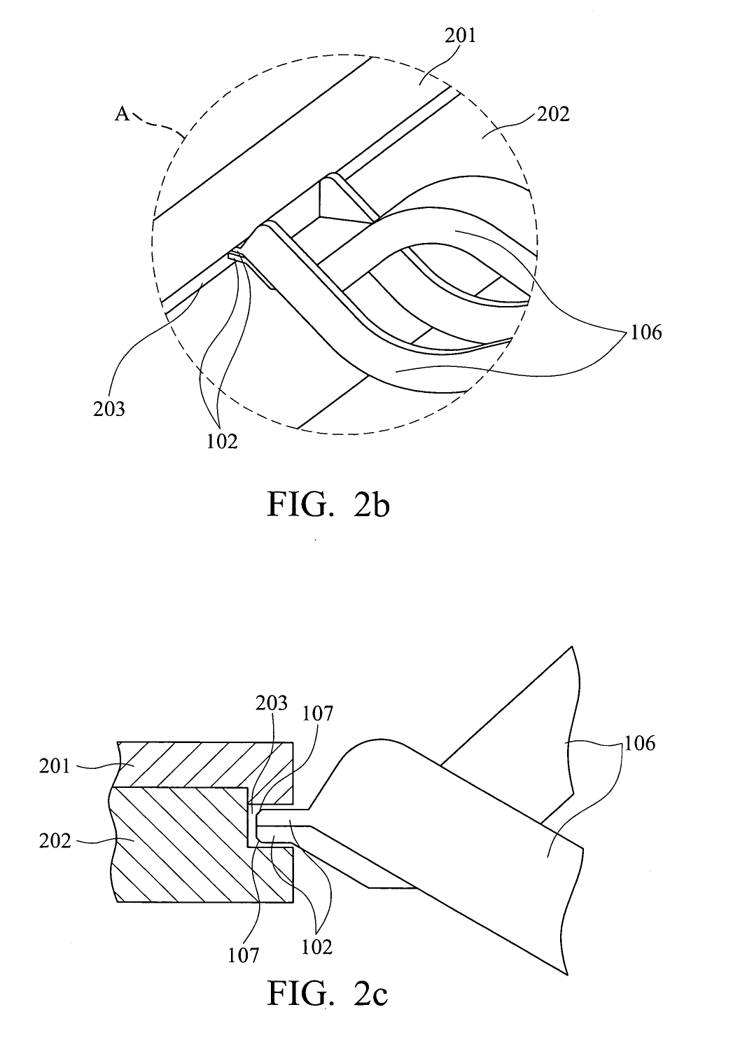

The pair of prying slices 102 is disposed on the pair of short arm portions 106 respectively. Each prying slice 102 comprises a leading angle 107 (clearly shown in FIG. 2c also).

The elastic component 103 is a compression spring connected between the pair of long arm portions 105.

Moreover, the long arm portion 105 and the short arm portion 106 of each handle 101 and the corresponding prying slice 102 thereon are integral and made of metal.

As shown in FIG. 1b, when the pair of long arm portions 105 receives an external force 300, the pair of prying slices 102 is separated.

As shown in FIG. 1a, when the external force 300 ceases, the elastic component 103 applies resilience on the pair of long arm portions 105 to tightly close the pair of prying slices 102.

FIG. 2a is a schematic diagram of the prying tool 100, wherein the pair of prying slices 102 is inserted into a groove 203 of a liquid crystal display (LCD) 200. FIG. 2b is an enlarged diagram of a dotted-line portion A in FIG. 2a. FIG. 2c is a cutaway view along a line B in FIG. 2a.

The prying tool 100 can separate engaged objects, such as a plastic front cover 201 and a plastic back cover 202 of the LCD 200.

A groove 203 formed where the plastic front cover 201 and the plastic back cover 202 meet is about 1 mm in width.

The pair of prying slices 102 of the prying tool 100 can be partly inserted into the groove 203 when tightly closed. Moreover, each prying slice 102 comprises the leading angle 107, such that the pair of prying slices 102 can be inserted into the groove 203 more easily.

When the pair of long arm portions 105 of the prying tool 100 receives the external force 300 (shown in FIG. 1b), the pair of prying slices 102 is separated. Thus, the plastic front cover 201 and the plastic back cover 202 can be separated easily.

Some embodiments of a prying tool utilize a pair of prying slices to separate a plastic front cover and a plastic back cover of a liquid crystal display (LCD) by inserting the pair of prying slices into a groove of the LCD where the plastic front cover and the plastic back cover meet.

Some embodiments of a prying tool can be operated by a single hand to separate engaged objects conveniently and safely, avoiding damage or deformity.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A prying tool for separating engaged objects having a groove formed where the objects meet, comprising:
a pair of handles, interlaced and rotatably pivoting on each other; and
a pair of prying slices, disposed on the pair of handles respectively;
wherein the pair of prying slices can be partly inserted into the groove when tightly closed.

2. The prying tool as claimed in claim 1, wherein when the pair of handles receives an external force, the pair of prying slices is separated, and when the external force ceases, the pair of prying slices is tightly closed.

3. The prying tool as claimed in claim 2 further comprising an elastic component, connected between the pair of handles.

4. The prying tool as claimed in claim 3, wherein when the external force ceases, the elastic component applies resilience on the pair of handles to tightly close the pair of prying slices.

5. The prying tool as claimed in claim 3, wherein the elastic component is a compression spring.

6. The prying tool as claimed in claim 1, wherein each prying slice comprises a leading angle.

7. The prying tool as claimed in claim 1, wherein each handle and the prying slice thereon are integral.

8. The prying tool as claimed in claim 1, wherein each handle is made of metal.

9. A prying tool for separating engaged objects having a groove formed where the objects meet, comprising:
a pair of handles, interlaced and rotatably pivoting on each other, wherein each handle comprises a long arm portion and a short arm portion respectively on two sides of a pivot point on which the pair of handles pivots; and
a pair of prying slices, disposed on the pair of short arm portions respectively;
wherein the pair of prying slices can be partly inserted into the groove when tightly closed.

10. The prying tool as claimed in claim 9, wherein when the pair of long arm portions receives an external force, the pair of prying slices is separated, and when the external force ceases, the pair of prying slices is tightly closed.

11. The prying tool as claimed in claim 10 further comprising an elastic component, connected between the pair of long arm portions.

12. The prying tool as claimed in claim 11, wherein when the external force ceases, the elastic component applies resilience on the pair of long arm portions to tightly close the pair of prying slices.

13. The prying tool as claimed in claim 11, wherein the elastic component is a compression spring.

14. The prying tool as claimed in claim 9, wherein each prying slice comprises a leading angle.

15. The prying tool as claimed in claim 9, wherein each short arm portion and the prying slice thereon are integral.

16. The prying tool as claimed in claim 9, wherein the long arm portion and the short arm portion of each handle are integral.

17. The prying tool as claimed in claim 9, wherein each handle is made of metal.
